(19) United States
(12) Patent Application Publication
(10) Pub. No.: US 2005/0099469 A1
(43) Pub. Date: May 12, 2005

(54) Ink conversion kit

(75) Inventors: Michel Encrenaz, Rubi (ES); Juan Uroz, Terrassa (ES); Paul R. Krouss, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/947,386

(22) Filed: Sep. 23, 2004

(30) Foreign Application Priority Data
Sep. 26, 2003 (EP) 03103581.9

(51) Int. Cl. B41J 2/17

(52) U.S. Cl. 347/84

(57) ABSTRACT

An ink kit for a printer device comprises: at least one print head capable of connecting with an ink supply tube of said printer device; at least one ink reservoir capable of connecting with said ink supply tube; and a pump device capable of connecting with said at least one ink supply tube of said printer device, for clearing said at least one ink supply tube of ink.

### FIELD OF THE INVENTION

The present invention relates to printers.

### BACKGROUND TO THE INVENTION

Known printer devices, especially for the proofing market, have ink sets which are optimized according to the particular market for which they are sold. For example printers produced for the proofing market use dye based ink sets, where color gamut is a key attribute. On the other hand, for markets where durability of prints is required, a pigmented ink set or other photo inks are used.

Referring to FIG. 1 herein, there is illustrated schematically in perspective view, a known printer device capable of printing large format print media, typical of the type of printers which are used in the proofing market, or for printing durable plots. The printer comprises a set of print heads which travel across a print media on a carriage, and a media transport mechanism which feeds a sheet of media past the print heads as the print heads move from side to side.

The print heads comprise a plurality of individual ink jet print heads fed by a set of ink reservoirs. The ink reservoirs remain stationery, fixed to a main chassis of the printer device, whilst the print heads move across the print media. Ink is supplied from the ink reservoirs to the print heads via a plurality of ink tubes, which are flexible, and which extend back and forth across a width of the printer device, as the print head moves across the sheet of media.

In known printers which are at an upper end of a range of printers provided by a manufacturer, a printer configuration can be switched from one ink set type to another. This involves a kit comprising a set of print heads, a set of ink reservoirs, and a new set of tubes. All of these components need to be replaced in order to change the ink type printed by the printer device. Changing an ink set in a prior art printer device typically involves an expensive kit, which replaces the whole of the ink path from the reservoirs through the ink tubes, and the print heads.

However, in known printers at a lower end of a range of printers, the facility to change ink types is not provided.

Referring to FIG. 2 herein, there illustrated schematically a printing system comprising a known computer device 200, and a known low end range ink jet printer device 201. The computer device 200 supplies print jobs to the printer device 201. Typically, end users purchase low end range ink jet printers for reasons of economy, low cost of ownership, smaller media size and storage space reasons compared to purchasing high end range printer devices. The known low end range printers may provide a wide color gamut with smooth transitions. Typically the ink jets may have a four picoliter drop size, and 2400 dots per inch (DPI) resolution to provide photo quality prints and proofs.

Referring to FIG. 3 herein, there is illustrated schematically in perspective view, one side of a printer device, showing a set of print heads 300 and a set of ink reservoirs 301. Print heads 300 travel on a carriage along a bar 302 in a direction across the media and transverse to a direction of movement of the media relative to the printer. A set of ink tubes 303 supply ink from the ink reservoirs to the plurality of print heads.

Each ink color has its own ink path comprising an ink reservoir storing ink of a single color; a print head for printing ink of a single color; and an ink tube connecting the ink reservoir to a print head. Typically, there may be six different inks comprising yellow ink; black ink; magenta ink; light magenta ink; cyan ink; and light cyan ink. Since the rates of usage of different inks vary, some of the ink reservoirs may have smaller capacity than others. For example the light cyan and light magenta ink reservoirs may have a smaller capacity than the cyan and magenta ink reservoirs.

Since there is no upgrade possibility, a user has to keep the same printer ink configuration as when the printer was originally sold to them. If a user requires a different printer ink configuration, then they must buy a completely separate printer device having a different ink set type.

### SUMMARY OF THE INVENTION

According to a first aspect of the present invention, there is provided an ink kit for a printer device, said ink kit comprising:
at least one print head capable of connecting with an ink supply tube of said printer device;
at least one ink reservoir capable of connecting with said ink supply tube; and
a pump device capable of connecting with said at least one ink supply tube of said printer device, for clearing said at least one ink supply tube of ink.

Said pump device may operate to clear said at least one ink supply tube by drawing ink through said at least one ink supply tube using capillary action.

Said ink kit may further comprise at least one cleaning fluid reservoir for containing cleaning fluid, said cleaning fluid reservoir capable of being fitted into a print head port of said printer device.

Said ink kit may further comprise a container device, said container device comprising at least one shaped receptacle adapted for holding;
said at least one print head; and
said at least one ink reservoir.

Said container may comprise at least one receptacle for holding a cleaning fluid reservoir.

The ink kit may further, comprise a print head driver component, said print head driver component being fittable to said printer device for converting said printer device to operate said at least one print head.

Said print head driver component may comprise a set of program instructions stored on a record medium.

Said print head driver component may comprise a static memory device containing a set of instructions for instructing a data processor of said printer device to drive said at least one print head.

According to a second aspect of the present invention, there is provided a method of changing an ink of a printer device, said method comprising:
connecting a pump device with at least one ink supply tube of said printer device, and clearing said at least one ink tube of ink;
connecting a print head with said at least one ink supply tube; and
connecting an ink reservoir with said at least one ink supply tube.

The method may further comprise applying a vacuum suction to a plurality of said ink supply tubes in a single operation.

The method may further comprise fitting a cleaning fluid reservoir into a print head port of said printer device; and
drawing cleaning fluid through a said ink supply tube using a manually operated vacuum pump device connected to another end of said ink supply tube.

The method may further comprise fitting a print head driver to said printer device, for driving said print head.

Said fitting a print head driver may comprise installing a card into said printer device, said card comprising said print head driver component.

Said fitting a print head driver may comprise storing program instructions into a memory device comprising said printer device.

The method may comprise:
placing a set of print heads for printing a first ink type, having been removed from said printer device, into a container device comprising a plurality of receptacles for storing a said plurality of first print heads.

The method may comprise placing a set of ink reservoirs for printing a first ink type, having been removed from said printer device, into a container device comprising a plurality of receptacles for storing a set of ink reservoirs.

The method may further comprise:
removing from said printer device a first print head capable of printing a first ink type; wherein
said print head connected with said at least one ink supply tube is capable of printing with a second ink type.

The method may further comprise:
removing from said printer device a first print head capable of printing a first ink color; wherein
said print head connected with said at least one ink supply tube is capable of printing with a second ink color.

The method may further comprise:
removing from said printer device a first ink reservoir capable of storing a first ink type; wherein
said reservoir connected with said at least one ink supply tube is capable of storing a second ink type.

The method may further comprise:
removing from said printer device a first ink reservoir capable of storing a first ink color; wherein
said reservoir connected with said at least one ink supply tube is capable of storing a second ink color.

According to a third aspect of the present invention, there is provided a method of adapting a printer device for printing a range of different ink types, said method comprising:
applying suction to one end of at least one ink supply tube of said printer device, to clean out said at least one ink supply tube;
fitting to said printer device a plurality of print heads for printing inks of a specific ink type included in said range of different ink types; and
fitting to said printer device a plurality of ink reservoirs containing inks of said specific ink type.

Said method may further comprise flushing said at least one ink supply tube with a cleaning fluid.

Said method may further comprise fitting a cleaning fluid reservoir to one end of said at least one ink supply tube, and drawing said cleaning fluid through said ink supply tube using said applied suction.

Said method may further comprise modifying a print head driver of said printer device, for driving said plurality of print heads to print said inks of said specific ink type.

According to a fourth aspect of the present invention, there is provided an ink conversion kit for converting a printer device for printing an ink set of a first specific ink type within a range of ink sets each comprising its own specific ink type, said conversion kit comprising:
a plurality of print heads suitable for printing inks of said first specific ink type;
a plurality of ink reservoirs containing inks of said first specific ink type;
said plurality of print heads being compatible with said plurality of ink reservoirs for printing said same inks of said common ink type; and
a pump device capable of connecting with a set of ink supply tubes of said printer device, for cleaning said ink supply tubes of ink.

According to a fifth aspect of the present invention, there is provided a pump device capable of connecting with at least one ink supply tube of a printer device, for clearing said at least one ink supply tube of ink, said pump device comprising:
a vacuum chamber capable of creating a reduction in pressure; and
a connection tube for connecting said vacuum chamber with one end of said ink supply tube for drawing ink out of said ink supply tube.

Said vacuum chamber may be manually operable for creating said reduction in pressure.

According to a sixth aspect of the present invention, there is provided an ink kit for a printer device, said printer device having at least one ink supply tube for carrying ink between an existing ink supply reservoir and an existing print head, said ink kit comprising:
a pump device, capable of connecting with said ink supply tube of said printer device for clearing said ink supply tube of ink,
at least one replacement print head for replacing said existing print head, and
at least one replacement ink supply reservoir, for replacing said existing ink reservoir, said ink kit operable in use such that,
after removal of said existing ink reservoir and said existing print head, said pump device is connectable to one end of said ink supply tube, and operable for drawing ink through said ink supply tube, thereby clearing said ink supply tube of ink, prior to connection of said replacement ink reservoir to one end of said ink supply tube and connection of said replacement ink supply tube to another end of said ink supply tube.

Advantages of the embodiments and methods described herein may include the following:

Firstly, a single ink jet printer device can be adapted by using an ink kit, to replace two known printers, each set up for a different ink type.

Secondly, cost of ownership of a printing system for printing two ink types is reduced, since only one printer needs to be purchased, with two or more interchangeable ink sets.

Thirdly, storage space requirements throughout the supply chain, and at the customers premises are reduced, since one printer having interchangeable ink sets replaces a plurality of known printers. Stockists of printer devices need only store one printer device type rather than a plurality of printer device.

Fourthly, minimal modification is required to prior art printer device, for fitting replacement or interchangeable ink sets. Modification consists of replacing ink reservoirs, print heads, and installing electronic drive components for driving additional print heads.

Other aspects of the invention are as recited in the claims herein, and the scope of the invention is limited only by the features of the attached claims.

### BRIEF DESCRIPTION OF THE DRAWINGS

For a better understanding of the invention and to show how the same may be carried into effect, there will now be described by way of example only, specific embodiments, methods and processes with reference to the accompanying drawings in which:

FIG. 1 illustrates schematically a large format known ink jet printer device suitable for proofing, or for printing of durable prints;

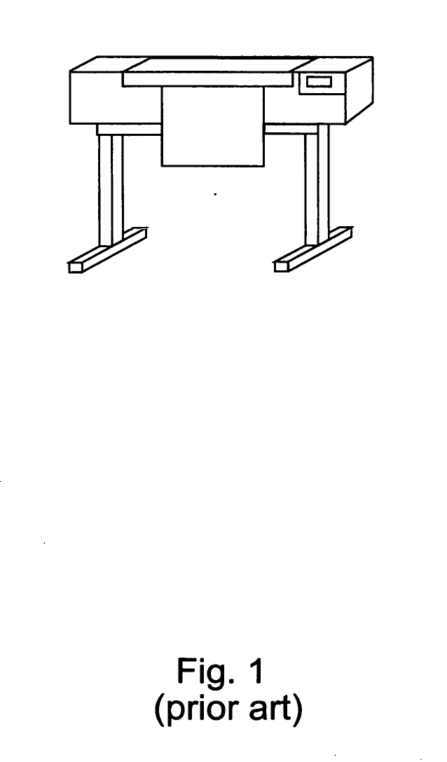

FIG. 2 illustrates schematically a known computer device, and known lower range ink jet printer device suitable for proofing;

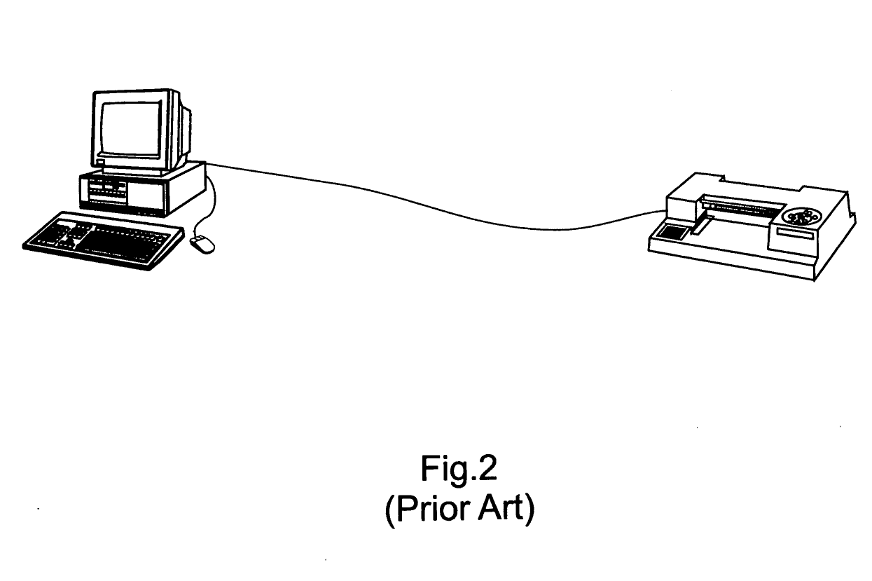

FIG. 3 illustrates schematically an ink set and a set of print heads of the known low end range printer device of FIG. 2;

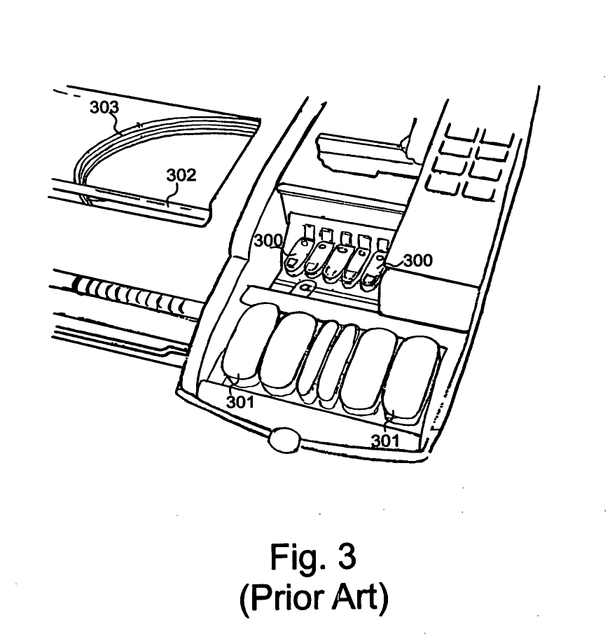

FIG. 4 illustrates schematically an ink type conversation kit according to a specific embodiment of the present invention, for converting a printer device to print using inks of a particular type;

FIG. 5 illustrates schematically a specific method according to the present invention, for removing print heads and ink reservoirs of a first ink type, and preparing a printer device for installation of an ink set of a second ink type;

FIG. 6 illustrates schematically a specific method according to the present invention, for fitting a replacement ink set of a second ink type to a printer device;

FIG. 7 illustrates schematically stages in the methods described with reference to FIGS. 5 and 6 herein for conversion of a printer device from a first ink type to a second ink type;

FIG. 8 illustrates schematically upgrade of a print head drive component for conversion of a printer device from printing inks of a first ink type, to printing inks of second type according to a further specific method of the present invention; and

FIG. 9 illustrates schematically a container comprising an ink kit, for housing and storing ink reservoirs, print heads, and other components of an ink set, according to a further specific embodiment of the present invention.

### DETAILED DESCRIPTION OF A SPECIFIC MODE FOR CARRYING OUT THE INVENTION

There will now be described by way of examples a description of the best mode contemplated by the inventors of implementing the invention. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

Specific implementations described herein provide for an upgrade kit for converting a printer device having a first ink set type, to a second ink set type.

In this specification, by “ink type” it is meant a type of ink irrespective of color. Examples of types which are different to each other include pigmented inks, and dye based inks. In this specification inks within a same ink set of a particular type, for example pigmented, but which are of different color to each other are not regarded as different ink types.

The conversion kit comprises a set of replacement print heads; a corresponding set of replacement ink reservoirs containing inks; one or more cleaning heads; and a pump device for cleaning ink tubes of a printer. Additionally, a print head controller conversion may be provided, for driving the replacement print heads, to print using the different ink type.

A printer device is supplied with an ink set of a first type. This may be either a proofing ink type, or an ink set of pigmented inks. A user of a printer device can manually perform changing of an ink set to a printer by removing the original print heads, removing the original ink reservoirs, flushing out any ink within the original ink tubes using the pump device, fitting the new set of print heads adapted for a different ink type, and fitting a new set of ink reservoirs having the different ink type.

Draining of the previous ink from the ink tubes is achieved by drawing the ink through the tubes using a vacuum created by the pump, and draining the tube into a drain reservoir. Capillary forces prevent ink traces from remaining inside the tube.

According to a specific method, a user of the printer can directly change an ink set by fitting an ink kit as described herein, performing manually a change to a printer's ink reservoirs, and a change of print heads. The user does not need to replace any ink tubes of the printer device, since the user can drain and optionally flush clean the ink tubes using a pump device, prior to fitting replacement ink reservoirs.

In the presently described implementations, an ink conversion kit for converting between a first ink type and a second ink type is described. However, in other implementations, three or more ink types may be provided, and correspondingly, two or more sets of print heads; and two or more sets of ink reservoirs; and two or more print head drivers may be provided for enabling a print head device to operate with one, two or more different ink types. A printer device operates a complete set of inks of a single type at any one time, and ink sets are interchangeable as a whole ink set.

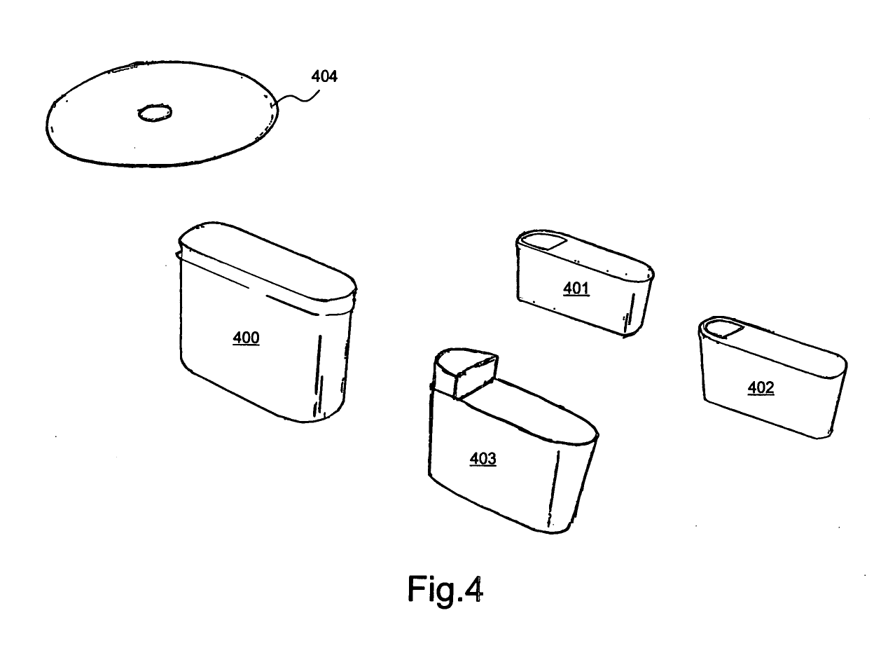

Referring to FIG. 4 herein, there is illustrated schematically an ink conversion kit according to a specific implementation of the present invention. The kit comprises: a plurality of ink reservoirs 400, one of which is shown there being a different ink reservoir supplied, filled with ink for each color; a plurality of print heads 401 one for each color of ink; one of which is shown in FIG. 4; one or more cleaning heads 402, which do not contain any ink, but which may contain cleaning fluid; and a manually operated vacuum pump device 403.

Manual pump 403 comprises a cylinder and plunger arrangement, and a flexible connection tube for connecting to an end of an ink tube. In use, the ink tubes of the printer device are provided with one way valves, so that ink flows from the reservoir to a print head, and not in a reverse direction. The vacuum pump provides sufficient suction as to draw ink through an ink tube, and through the valves, so that ink is drawn into a reservoir within the pump, thereby cleaning the ink tubes.

In the embodiment shown in FIG. 4, a single pump is alternately used for each of the ink tubes, one at a time.

One or more cleaning heads 402 are supplied in the kit. The cleaning head can be fitted to a second end of an ink tube, which normally connects to a print head, to replace a print head. The manual pump can be fitted to the first end of the tube, to draw ink through the tube, in an opposite direction to the valves, the vacuum provided by the pump overcoming the resistance of the valves to draw ink through the ink tube. Normally, capillary action ensures that the ink draws through the tube, leaving no residual traces of ink. However, in some cases residual ink may be left within the tube. In these cases, the cleaning head, which contains a supply of cleaning fluid, can be used to flush out an ink tube, by passing cleaning fluid through the ink tube from the cleaning head from the second end of the tube towards the first end of the tube, drawn by the manually operated vacuum pump. Use of the cleaning head is optional, depending upon whether a clean tube can be obtained with or without flushing with cleaning fluid.

A single cleaning head may be provided in a kit, where the cleaning head is alternately connected to different ink tubes as each ink tube is purged of ink individually, or a plurality of cleaning heads may be provided, where a plurality of ink tubes are purged of ink in parallel.

The ink conversion kit further comprises a print head drive component 404 which can be installed into the printer device, for driving the print heads. Since the printer device as originally supplied prints using a first ink type, and a first print head type suitable for that first ink type, in some instances, the first print head type may be unsuitable for printing ink of a second type. Since a second type of print head is supplied in the kit, this may require a different drive component within the printer for electronically driving one or more such print heads of the second type.

Depending upon the design of the printer device, the drive component can be changed in a variety of ways. For printer devices where the drive component is implemented as a firmware component, for example a programmable logic array (PLA), then a replacement programmable logic array may be fitted as a component to the printer device. Where the printer device operates by driving the print heads using a data processor in accordance with program instructions, stored in a memory, for example an electrically erasable programmable read only memory (EEPROM) then reconfiguration of the printer device may be carried out by loading a new set of program instructions from a data storage carrier such as a CD-ROM, into a host computer entity, and then loading the program instructions from the computer entity into the printer devices memory over an interface.

The drive component may be supplied in a variety of physical forms, depending upon the design and configuration of the printer device. However, a first print head driver capable of driving the first set of print heads for the first ink type can be substituted for driving a second set of print heads for printing a second ink type. The first print driver may reside within the printer device as well as the second print driver, in which case, either the first print driver or the second print driver may be activated depending upon whether the first or second sets of print heads are installed.

Similarly, for further print head sets for further ink set types, corresponding respective further print head drivers may be supplied.

In an alternative embodiment, a vacuum pump device, has a plurality of connection tubes, for connecting one connection tube to each ink tube, and a single vacuum chamber capable of creating a vacuum in each of the connecting tubes, and thereby drawing ink from a plurality of ink tubes. The second embodiment vacuum pump is designed for connecting to a plurality of ink tubes simultaneously, to draw ink through the plurality of ink tubes in parallel in a single operation.

A second vacuum pump embodiment comprises a vacuum chamber having a piston plunger capable of being manually withdrawn relative to the body of the vacuum chamber, thereby creating a vacuum internally. The chamber body is provided with a connector, preferably of a flexible plastics material, which connects with the ink tubes, such that when the connector is presented to a plurality of ink reservoirs in parallel, simultaneous connection of each of the connectors can be made to all of the ink tubes so that all of the ink tubes can be drained in one operation.

In one embodiment, in order to change a set of inks and convert the printer from one ink set type to another, in a printer having inks of the types yellow, black, magenta, light magenta, cyan and light cyan, the user performs the following steps. The user removes the yellow ink reservoir and the yellow print head. The user loads the manual pump into a yellow reservoir slot in the printer device and loads the cleaning head into the print head slot for the yellow print head. The user purges the yellow ink tube using the manual pump. The user removes the black ink reservoir and the black print head. The user loads the manual pump in the black reservoir slot and loads the cleaning head in the black print head slot. The user purges the black ink tube using the manual pump. The user removes the magenta ink reservoir and the magenta print head and loads the manual pump in the magenta reservoir slot. The user loads the cleaning head in the magenta print head slot and purges the magenta tube using the manual pump. The user removes the cyan ink reservoir and the cyan print head and loads the manual pump into the slot for the cyan reservoir. The cleaning head is inserted into the cyan print head slot and the cyan tube is purged using the manual pump. The user removes the light magenta ink reservoir and the light magenta print head and loads the manual pump into the slot for the light magenta reservoir. The user loads the cleaning head into the light magenta print head slot and purges the light magenta tube. The user removes the light cyan ink reservoir and removes the light cyan print head. The user loads the manual pump into the reservoir slot for the light cyan reservoir, and loads the cleaning head into the slot for the light cyan print head. The user purges the light cyan tube using the manual pump.

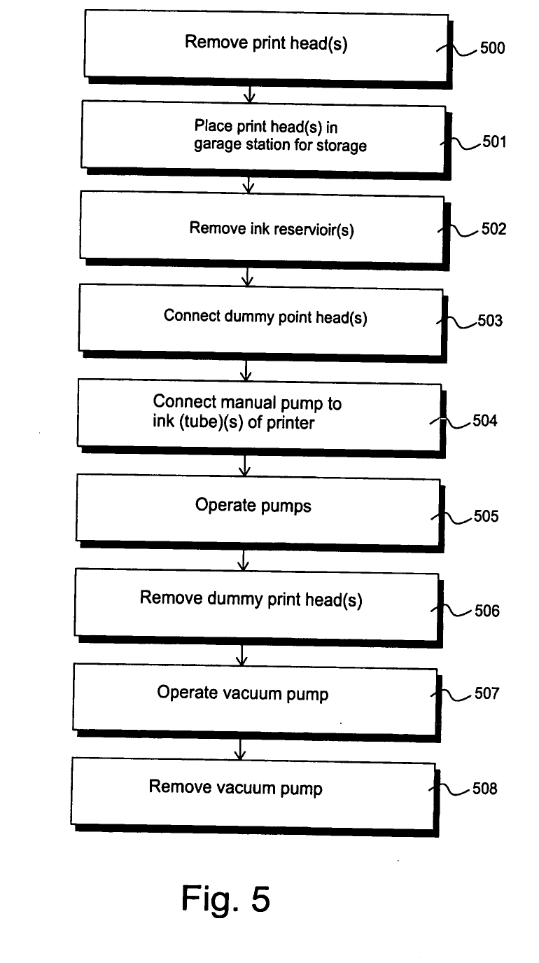

Referring to FIG. 5 herein, there is illustrated schematically process steps carried out by a user, using the ink conversion kit, for replacing an ink reservoir on a known printer device, for converting the printer device to a different ink type. FIG. 5 illustrates processes carried out for replacement of a single print head using an ink kit as described with reference to FIG. 4 herein having a manual pump capable of connecting to a single ink tube, one at a time. It will be appreciated that the process steps carried out are the same for each ink tube of the printer device.

In process 500, the user removes a print head of a first type from the printer device. In process 501, the user places the print head in a container for storage. This provides protection for the print head against damage and to keep the print head clean and prevent ink coagulation. In process 502, the user removes the ink reservoir of a first type. In process 503, optionally, the user connects a cleaning head. The cleaning head contains a cleaning fluid, which can be drawn through an ink tube, to dissolve any remaining ink in the tube, making the ink less viscuous and therefore easier to draw through the tube. In process 504, the user connects the manual pump to an end of the ink tube opposite to the end which the cleaning head is connected to. In process 505, the user operates the pump to create a vacuum. Any ink remaining in the ink tube is drawn towards the vacuum pump and is drawn into a vacuum chamber. Where the cleaning head has been fitted, cleaning fluid may also be drawn through the ink tube.

The stage 503 of fitting the cleaning head may be optional, since it has been found that for some ink tubes, the capillary action created when the ink is drawn through the tube towards the vacuum pump leaves the tube clean of any remaining ink, and therefore cleaning fluid is found unnecessarily. Therefore, fitment of the cleaning head containing the cleaning fluid is optional, depending upon whether the operation of cleaning of tubes can be successfully carried out without cleaning fluid.

In process 506, the user removes the cleaning head, so as to prevent drawing further cleaning fluid into the ink tube. In process 507, the user continues to operate the vacuum pump, to draw any remaining cleaning fluid through the ink tube. At this stage, due to capillary action, all of the cleaning fluids should be drawn into the vacuum pump, leaving the ink tube completely clean. However, there is a possibility that small amounts of cleaning fluid may remain in the ink tube.

The user then removes the vacuum pump, in process 508, leaving a completely clean ink tube, or an ink tube having a residue of cleaning fluid there within.

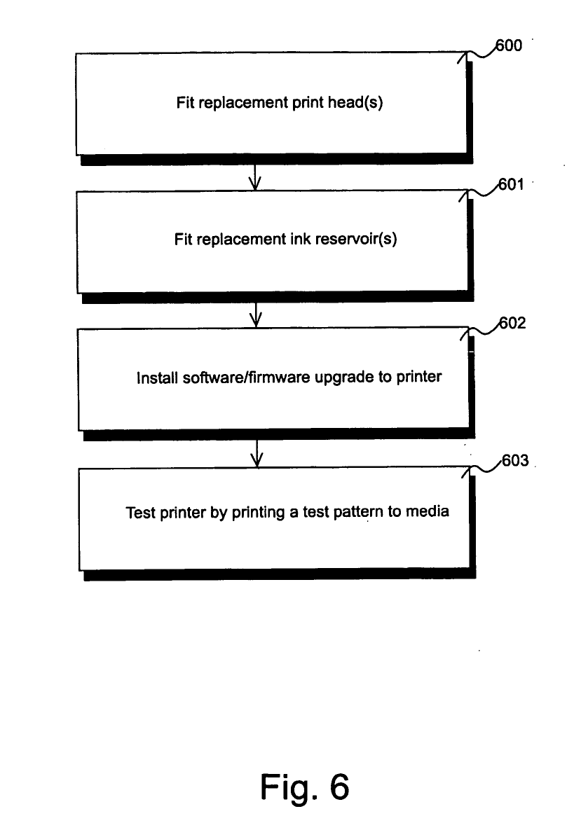

Referring to FIG. 6 herein, there is illustrated schematically process steps carried out by a user for fitment of a replacement ink set. In process 600, the user fits a replacement print head of a second type to a first end of an ink tube. In process 602 the user fits a replacement ink reservoir of the second different ink type, and of the correct color to a second end of the ink tube.

Processes 600, 601 are repeated for each of the ink tubes, so that a full set of print heads and full set of ink reservoirs are fitted.

In process 602, the user installs a print head driver component in the form of software or firmware upgrade into the printer for driving the replacement print heads capable of printing the different ink type. In process 603, the user tests the printer by printing a test pattern to a media sheet. During the test printing, any cleaning fluid remaining in the ink tubes flows through the replacement print heads as the fluid is pushed along the ink tube by the new ink of a different type, from the replacement reservoir. After printing of the test pattern, the printer is now ready for use, having the ink type changed from the original first ink type, to a replacement second ink type, with the print head driver component for driving the print heads also having been installed.

If the user wishes to convert the printer back from the second ink type to the first ink type again, then the processes as described in FIGS. 5 and 6 are repeated, this time removing the print heads and reservoirs of the second type, purging the tubes of ink, fitting the print heads and ink reservoirs of the first type, installing and/or activating the original print head driver, and printing a test pattern, after which, the printer device is reset to use ink of the first type.

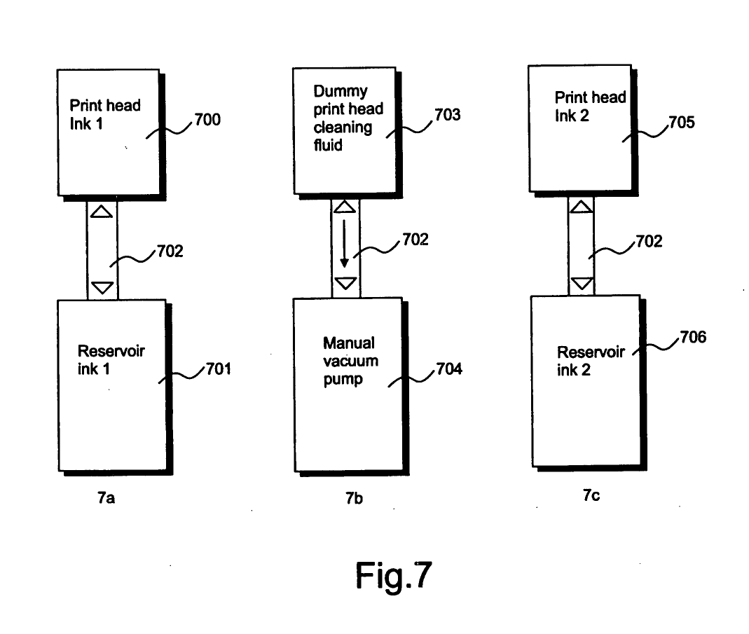

Referring to FIG. 7 herein, there is illustrated schematically three stages of the conversion process using the ink kit as described herein. In FIG. 7A there is illustrated schematically a first print head having first ink type 700; a first ink reservoir 701 containing a first ink type of a particular color; and a first ink tube 702 connecting the first ink reservoir and the first print head.

In FIG. 7B, there is illustrated schematically the ink tube 702, one end of which is connected to a cleaning head 703 containing cleaning fluid, and a second end of the ink tube is connected to a manual vacuum pump 704. Ink is drawn through the ink tube 702 and optionally, cleaning fluid is also drawn through the ink tube so that the ink of the first type, and optionally the cleaning fluid, is drawn into a reservoir of the manual vacuum pump 704. Ink and cleaning fluid is drawn through the valves of the ink tube, due to the pressure difference caused by the vacuum pump.

Referring to FIG. 7C herein, there is illustrated a replacement of the print head by a second print head 705 suitable for printing a second ink type to one end of the ink tube 702, and fitment to the other end of the ink tube of a replacement ink reservoir containing ink of a second type, of a same color as previously.

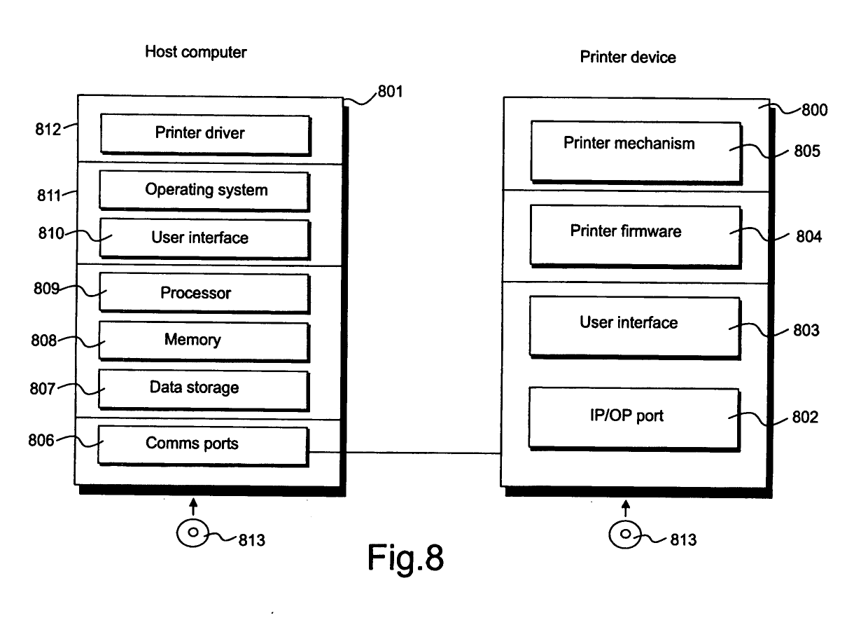

Referring to FIG. 8 herein, there is illustrated schematically components of a printer device 800, and a host computer entity 801 from which the printer device is driven.

The printer device comprises an input/output port 802; a user interface 803, which may include a plurality of keypad buttons for activating various features, and/or a port for accepting a data storage device, for example a floppy disk or CD-ROM drive; a chip set 804 containing a print head driver component for driving the print heads of a printer mechanism 805.

Host computer entity 801 comprises a set of communications ports 806 for communicating with the printer device; a data storage device 807 as is known in the art, for example hard disk drive unit; a memory device 808; a known processor device 809; a user interface 810 comprising typically a visual display device, a keyboard for text and character data entry, and a pointing device such as a mouse or the like; an operating system 811 as is known in the art, and a printer driver 812.

A software program carried on a data storage medium 813 such as a CD-ROM or the like, for upgrading the printer device to print ink of a different type can be input into the host computer entity 801, or where the printer device has a port for accepting of the data storage medium, directly into the printer device. Printer frimware 904 may comprise a data processor and an area of associated memory which can be used to store program code instructions. The program code instructions cause the data processor to control the printer mechanism, including controlling the print heads, for printing.

For each type of print head for printing a different ink type, there is required a different set of program code instructions for driving the print head. The printer may be supplied with a first set of program code instructions configured for driving the print heads according to a first ink type with which the printer device is originally supplied. However, when the print heads are changed for a different ink type, a different set of program code instructions are required to be loaded into the printer device in order to drive the replacement print heads of the second ink type.

When changing ink between first and second types regularly, it is possible that ink residues may remain in the ink tubes. Therefore, some contamination of ink type may be experienced, even where the cleaning fluid is thoroughly used. Therefore, the sets of ink types should be selected so as to be compatible, in that a minor contamination of a print head for a first ink type by a second type of ink will not cause malfunction of the first print head. Similarly, a first ink type should be selected so that if a small amount of the first ink type contaminates a print head designed for printing ink of a second type, the second print head will still function.

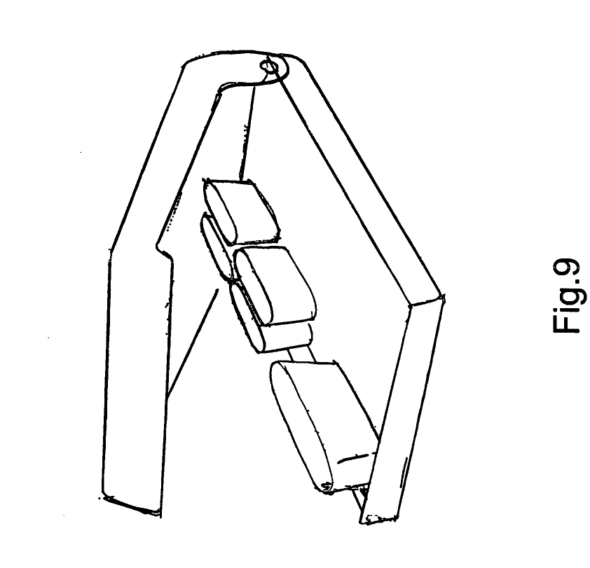

Referring to FIG. 9 herein there is illustrated schematically a set of reservoirs, print heads and cleaning heads in a container. The container is used for storing the reservoirs, print heads, vacuum pump, and cleaning heads when not in use. An ink set including print heads, and reservoirs can be stored within the container, which protects the print heads and reservoirs, the container being specially molded and/or adapted to shape the reservoirs and print heads so as to the keep them free of damage and clean when in storage.

It will be appreciated by persons skilled in the art that whilst specific embodiments have been described above which have replacement ink sets which are incompatible with each other, in some embodiments, ink sets which are of the same or a similar type could be used as replacement ink sets. Therefore, a print head could be capable of printing more than one ink type, and/or more than one color of ink, and ink reservoirs having different colors within an ink set could be exchanged around to print on different print heads within a same set of print heads. For example, in a printer device comprising an ink set of Cyan, Magenta, Yellow, and two black ink reservoirs and corresponding print heads, it is feasible to exchange print heads and reservoirs around within an ink set, with the dual black providing an increased printing speed for text modes.

However, this may be non-optimal, since it would be undesirable to use a single print head to print two different inks either of the same type and different colors, or of different types, because this could result in having cross contamination of inks. Further, having exchangeable print heads and ink reservoirs may lead to a user setting up their printer incorrectly by placing a wrong color ink in a slot.

1. An ink kit for a printer device, said ink kit comprising:
at least one print head capable of connecting with an ink supply tube of said printer device;
at least one ink reservoir capable of connecting with said ink supply tube; and
a pump device capable of connecting with said at least one ink supply tube of said printer device, for clearing said at least one ink supply tube of ink.

2. The ink kit as claimed in claim 1, wherein said pump device operates to clear said at least one ink supply tube by drawing ink through said at least one ink supply tube using capillary action.

3. The ink kit as claimed in claim 2, further comprising at least one cleaning fluid reservoir for containing cleaning fluid, said cleaning fluid reservoir capable of being fitted into a print head port of said printer device.

4. The ink kit as claimed in claim 1, further comprising a container device, said container device comprising at least one shaped receptacle adapted for holding;
said at least one print head; and
said at least one ink reservoir.

5. The ink kit as claimed in claim 4, wherein said container comprises at least one receptacle for holding a cleaning fluid reservoir.

6. The ink kit as claimed in claim 1, comprising a print head driver component, said print head driver component being fittable to said printer device for converting said printer device to operate said at least one print head.

7. The ink kit as claimed in claim 6, wherein said print head driver component comprises a set of program instructions stored on a record medium.

8. The ink kit as claimed in claim 6, wherein said print head driver component comprises a static memory device containing a set of instructions for instructing a data processor of said printer device to drive said at least one print head.

9. A method of changing an ink of a printer device, said method comprising:
connecting a pump device with at least one ink supply tube of said printer device, and clearing said at least one ink tube of ink;
connecting a print head with said at least one ink supply tube; and
connecting an ink reservoir with said at least one ink supply tube.

10. The method as claimed in claim 9, further comprising:
applying a vacuum suction to a plurality of said ink supply tubes in a single operation.

11. The method as claimed in claim 9, further comprising:
fitting a cleaning fluid reservoir into a print head port of said printer device; and
drawing cleaning fluid through a said ink supply tube using a manually operated vacuum pump device connected to another end of said ink supply tube.

12. The method as claimed in claim 9, further comprising:
fitting a print head driver to said printer device, for driving said print head.

13. The method as claimed in claim 12, wherein said fitting a print head driver comprises:
installing a card into said printer device, said card comprising said print head driver component.

14. The method as claimed in claim 12, wherein said fitting a print head driver comprises:
storing program instructions into a memory device comprising said printer device.

15. The method as claimed in claim 9, comprising:
placing a set of print heads for printing a first ink type, having been removed from said printer device, into a container device comprising a plurality of receptacles for storing a said plurality of first print heads.

16. The method as claimed in claim 9, comprising:
placing a set of ink reservoirs for printing a first ink type, having been removed from said printer device, into a container device comprising a plurality of receptacles for storing a set of ink reservoirs.

17. The method as claimed in any one of claims 9, further comprising:
removing from said printer device a first print head capable of printing a first ink type; wherein
said print head connected with said at least one ink supply tube is capable of printing with a second ink type.

18. The method as claimed in claims 9, further comprising:
removing from said printer device a first print head capable of printing a first ink color; wherein
said print head connected with said at least one ink supply tube is capable of printing with a second ink color.

19. The method as claimed in claim 9, further comprising:
removing from said printer device a first ink reservoir capable of storing a first ink type; wherein
said reservoir connected with said at least one ink supply tube is capable of storing a second ink type.

20. The method as claimed in claim 9, further comprising:
removing from said printer device a first ink reservoir capable of storing a first ink color; wherein
said reservoir connected with said at least one ink supply tube is capable of storing a second ink color.

21. A method of adapting a printer device for printing a range of different ink types, said method comprising:
applying suction to one end of at least one ink supply tube of said printer device, to clean out said at least one ink supply tube;
fitting to said printer device a plurality of print heads for printing inks of a specific ink type included in said range of different ink types; and
fitting to said printer device a plurality of ink reservoirs containing inks of said specific ink type.

22. The method as claimed in claim 21, further comprising flushing said at least one ink supply tube with a cleaning fluid.

23. The method as claimed in claim 21, further comprising fitting a cleaning fluid reservoir to one end of said at least one ink supply tube, and drawing said cleaning fluid through said ink supply tube using said applied suction.

24. The method as claimed in claim 21, further comprising modifying a print head driver of said printer device, for driving said plurality of print heads to print said inks of said specific ink type.

25. An ink conversion kit for converting a printer device for printing an ink set of a first specific ink type within a range of ink sets each comprising its own specific ink type, said conversion kit comprising:
a plurality of print heads suitable for printing inks of said first specific ink type;
a plurality of ink reservoirs containing inks of said first specific ink type;
said plurality of print heads being compatible with said plurality of ink reservoirs for printing said same inks of said common ink type; and
a pump device capable of connecting with a set of ink supply tubes of said printer device, for cleaning said ink supply tubes of ink.

26. A pump device capable of connecting with at least one ink supply tube of a printer device, for clearing said at least one ink supply tube of ink, said pump device comprising:
a vacuum chamber capable of creating a reduction in pressure; and
a connection tube for connecting said vacuum chamber with one end of said ink supply tube for drawing ink out of said ink supply tube.

27. The pump device as claimed in claim 26, wherein said vacuum chamber is manually operable for creating said reduction in pressure.

28. An ink kit for a printer device, said printer device having at least one ink supply tube for carrying ink between an existing ink supply reservoir and an existing print head, said ink kit comprising:
a pump device, capable of connecting with said ink supply tube of said printer device for clearing said ink supply tube of ink,
at least one replacement print head for replacing said existing print head, and
at least one replacement ink supply reservoir, for replacing said existing ink reservoir, said ink kit operable in use such that,
after removal of said existing ink reservoir and said existing print head, said pump device is connectable to one end of said ink supply tube, and operable for drawing ink through said ink supply tube, thereby clearing said ink supply tube of ink, prior to connection of said replacement ink reservoir to one end of said ink supply tube and connection of said replacement ink supply tube to another end of said ink supply tube.
